(19) United States
(12) Patent Application Publication
(10) Pub. No.: US 2006/0023216 A1
(43) Pub. Date: Feb. 2, 2006

(54) Integrated luminescence read device

(76) Inventors: Pierre Labeye, Grenoble (FR); Patrick Pouteau, Voreppe (FR); Francois Perraut, Saint Joseph De Riviere (FR); Frederic Ginot, Saint-Egreve (FR)

Correspondence Address: Thelen Reid & Priest, PO Box 640640, San Jose, CA, 95164-0640, US

(21) Appl. No.: 10/532,167

(22) PCT Filed: Oct. 23, 2003
(86) PCT No.: PCT/FR03/50103

§ 371 Date: Apr. 20, 2005

(30) Foreign Application Priority Data
Oct. 24, 2002 (FR) 02/13302

(51) Int. Cl. G01N 21/64

(52) U.S. Cl. 356/417

(57) ABSTRACT

The invention concerns a device (1) for testing at least one sample by optical detection of luminescence, comprising a site for receiving (3) the sample, said site being arranged in such a way that the sample can receive a luminescence excitation and emit a luminescence light in an optical guiding plane (2) of the device, the device further comprising collection means (7) optically connected to the optical guiding plane (2) to receive the luminescence light. The device further comprises means that make it possible to send back towards the collection means (4) a part of the luminescence light emitted in the optical guiding plane and not directly collected by the collection means.

### TECHNICAL FIELD

The invention concerns an integrated luminescence reading device. It finds an application in the field of biochips, in other words micro-devices intended to receive biological samples that one wishes to test. It applies in particular to a new model of biochips integrating the function of reader of luminescence from biological samples in the chip.

### STATE OF THE PRIOR ART

In the field of biochips, the testing of biological samples is usually carried out by optical detection of fluorescence. All of said samples are subjected to an excitation that induces, in particular, an emission of light or luminescence. The excitation may be a chemical reaction that produces light. However, very often, the excitation is a light beam and the sample then produces a light known as fluorescence. The most widely used configuration consists in using a microscope functioning in epi-illumination, in other words that the surface of the chip having the biological samples is lit by means of a light source focused by a microscope lens and that the fluorescent light emitted by a biological sample is collected by the same lens or by etched diffraction networks redirecting the fluorescent light emitted in certain directions.

According to a second configuration, the excitation of the fluorescent particles is carried out by a light beam conveyed by a guide plane formed in a plane of the chip and the recovery of the fluorescent light is achieved by a standard microscope.

According to a third configuration, the fluorescence excitation is carried out by a waveguide formed in a plane of the chip and the recovery of the fluorescent light emitted is achieved by a waveguide also formed in the plane of the chip (see the document CH-A-660 633).

According to a fourth configuration, much rarer, the fluorescence, excitation is carried out by means of a beam lighting the face of the chip having the biological samples and the recovery of the fluorescent light emitted is achieved by a waveguide formed in the plane of the chip (see documents DE-A-196 51 935 and JP-A-11-023 468).

All-of these configurations of the prior art have a certain number of disadvantages.

When the excitation beam is introduced into the chip by means of an optical waveguide, there is the problem of the coupling of the excitation light in the optical waveguide, which imposes quite strict positioning tolerances and thus alignment systems having a high cost.

Furthermore, there is the problem of the efficiency of the collection of the fluorescent light emitted. Indeed, the light emitted by the fluorescent particles or molecules is mainly confined in the plane of the chip and is emitted in all directions of said plane.

The article “Integrating Waveguide Biosensor” by F. S. Ligler et al., which appeared in Analytical Chemistry, Vol. 74, N^{o}3, 1st Feb. 2002, pages 713 to 719, proposes combining capillaries with a biochip for the optical detection of fluorescence. However, the advantages of these capillaries are only functional. They do not allow any optimisation to improve the measurement performances. Finally, due to their geometry, the capillaries, like optic fibre probes, do not make it possible to provide a support with numerous biological recognition contacts.

### DESCRIPTION OF THE INVENTION

The invention enables these problems to be remedied by favouring the luminescence light emitted and that is trapped in the chip. By forming a waveguide, for example with a high index difference, there is more light emitted in the chip than towards the exterior of the chip. However, if this light remains confined in a plane of the chip, it is emitted in all the directions of said plane.

The subject of the invention is therefore a device for testing at least one sample by optical detection of luminescence, comprising a site for receiving the sample, said site being arranged in such a way that the sample can receive a luminescence excitation and emit a luminescence light in an optical guiding plane of the device, the device further comprising collection means optically connected to the optical guiding plane for collecting the luminescence light, characterised in that the device further comprises, in the optical guiding plane, means that make it possible to send back towards the collection means a part of the luminescence light emitted in the optical guiding plane and not directly collected by the collection means.

The test device may further support means of detecting the luminescence light, said detection means being arranged at the output of the collection means. In this case, if the device is formed on a substrate, the optical guiding plane may be a plane parallel to the substrate and the luminescence light detection means may be arranged along a plane perpendicular to said plane parallel to the substrate.

The means enabling a part of the luminescence light to be sent back towards the collection means may be chosen from among: an elliptic mirror, a parabolic mirror, a photonic forbidden band structure, a resonating disc type structure and one or several focusing lenses.

The collection means may comprise at least one optical waveguide. They may be located on a wafer of the device on which ends the optical guiding plane. They may further comprise means of filtering the excitation light beam.

The test device may comprise several sites for receiving samples.

It may be formed from a silicon substrate coated successively with a first layer of silicon oxide, a layer of silicon nitride acting as optical guiding plane and a second layer of silicon oxide in which is formed the site for receiving the sample.

The sample may be a biological sample chosen from among a micro-organism such as a bacteria, a fungus, a virus, a chemical compound, a healthy or tumorous cell, a molecule such as a peptide, a protein, an enzyme, a polysaccharide, a lipid, a lipoprotein, a nucleic acid, a hormone, an antigen, an antibody, a growth factor, or a hapten.

### BRIEF DESCRIPTION OF DRAWINGS

The invention will be more fully understood and other advantages and particularities will become clearer on reading the following description, given by way of example and in nowise limitative, and by referring to the appended drawings among which:

FIG. 1 is a schematic overhead view of a first embodiment of the invention,

FIG. 2 is a schematic overhead view of a second embodiment of the invention,

FIG. 3 is a schematic overhead view of a third embodiment of the invention,

FIG. 4 is an overhead view showing a parabolic recovery mirror that may be used for the present invention,

FIG. 5 is an overhead view showing a system for refocusing the fluorescent light that may be used for the present invention,

FIG. 6 is an explanatory diagram of the operation of an elliptic mirror that may be used for the present invention,

FIG. 7 shows a combination of an elliptic mirror and lenses that may be used for the present invention,

FIG. 8 is a longitudinal section view of a test device according to the present invention,

FIG. 9 is a cross-sectional view of a test device according to the present invention,

FIG. 10 is an overhead view of a part of a test device according to the invention, this view showing a focusing lens and an optical waveguide,

FIGS. 11A and 11B are cross-sectional views of FIG. 10, respectively along the cross-sections AA and BB.

### DETAILED DESCRIPTION OF EMBODIMENTS OF THE INVENTION

The following description will be concerned with the specific case of light that is fluorescence.

The invention makes it possible to form integrated optical structures on a chip and to recover, on the wafer of the chip, the fluorescent light emitted by the biological samples present on said chip. The excitation of the samples may be carried out indiscriminately from above, from below if the support used is transparent to the wavelength of the excitation beam or by a same optical waveguide acting to convey the excitation beam and the fluorescent light emitted.

According to the invention, one seeks to recover the maximum fluorescent light emitted in all of the directions of the optical guiding plane and to direct the recovered fluorescent light towards one or several photodetectors.

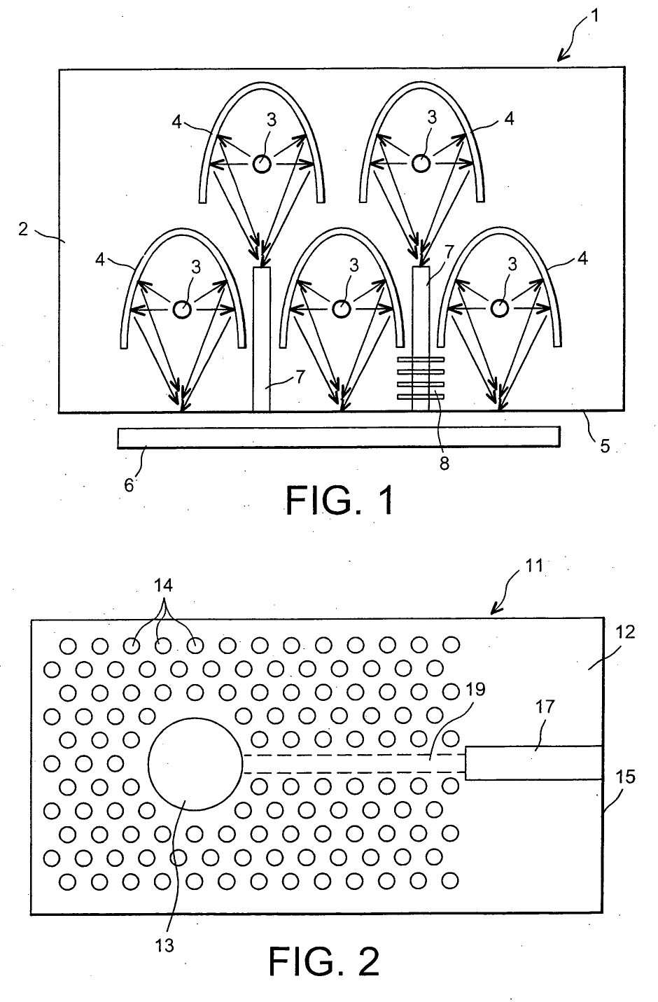

FIG. 1 is a schematic overhead view of a first embodiment of the invention. It shows the test device 1 along a cross-section corresponding to the optical guiding plane 2 of the device. The reference 3 designates test contacts bearing a sample to be analysed. An elliptic mirror 4 surrounds each contact 3 in such a way as to direct the fluorescent light emitted by the sample towards the wafer 5 of the device, which is equipped with strips of photodetectors 6.

For the test contacts 3 situated the nearest to the wafer 5, the mirrors 4 focus the fluorescent light directly onto the wafer 5. For the test contacts 3 situated further from the wafer 5, the mirrors 4 focus the fluorescent light onto an end of an optical waveguide 7 that conveys said light up to the wafer 5. The collection means may therefore consist simply of the wafer of the test device or consist of the combination formed by an optical waveguide and the wafer.

If necessary, a filtering network 8 may be combined with the optical waveguide 7 to reduce the parasite light conveyed by said guide. The filtering may be obtained by a Bragg network or by an evanescent coupler.

FIG. 2 is a schematic overhead view of a second embodiment of the invention. It shows the test device 11 along a section corresponding to the optical guiding plane 12 of the device. The reference 13 designates a test contact bearing a sample to be analysed. In this embodiment, the optical guiding plane comprises a photonic forbidden band structure, adapted to the fluorescence emission spectral band, consisting of a plurality of contacts 14 distributed in such a way as to canalise the fluorescent light towards a passage 19.

In the example shown, an optical waveguide 17 makes it possible to convey the fluorescent light leaving the passage 19 up to the wafer 15 of the device 11. The advantage of photonic forbidden band structures is that they can also perform the function of filtering the excitation light.

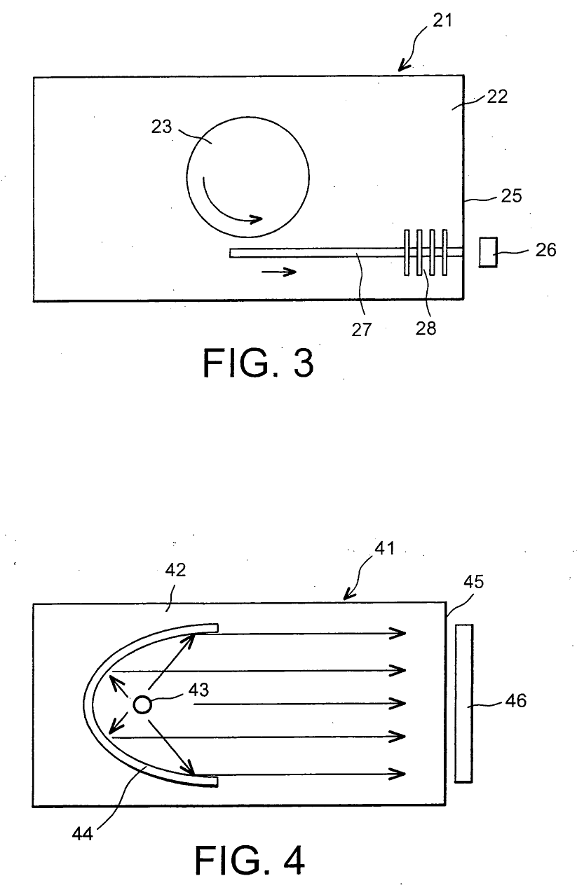

FIG. 3 is a schematic overhead view of a third embodiment of the invention. It shows the test device 21 along a cross-section corresponding to the optical guiding plane 22 of the device. The reference 23 designates a test contact on a resonating disc, the test contact bearing a sample to be analysed.

The resonating disc makes it possible to better process the light emitted by the fluorophores of the sample. In this case, the emitted light propagates in a circle following the propagation modes of the disc and, in the example shown, is coupled by evanescent wave towards a microguide 27 situated near to the resonating disc. If the disc is correctly dimensioned to have the resonance conditions corresponding to the emission wavelength of the fluorophore, one can benefit from the resonance amplification effect in the cavity to maximise the signal. The resonance condition is given by the formula:

$$\frac{2 π nL}{λ} = 2 k π$$

where n is the effective index of the first mode of propagation in the guiding structure, L is the perimeter of the disc, λ is the resonance wavelength and k any whole number corresponding to the interference order.

The geometry of the coupler may be optimised by different techniques (BPM, coupled mode theory, etc.), the objective being to maximise the output optical power given the resonator and the different propagation losses in the disc.

The microguide 27 conveys the emitted fluorescent light up to the wafer 25 of the device 21 where a photodetector 26 receives the fluorescent light detected. A filtering network 28 may if necessary be combined with the microguide 27.

FIG. 4 is an overhead view showing a parabolic recovery mirror that may be used for the present invention. On the optical guiding plane 42 of a test device 41 or chip, a single test contact 43 has been shown. It is surrounded by a parabolic mirror 44 that makes it possible to send back towards the wafer 45 of the device, on which is arranged a large surface area photodetector 46, light rays of a fluorescent light. The light rays sent back are parallel to each other.

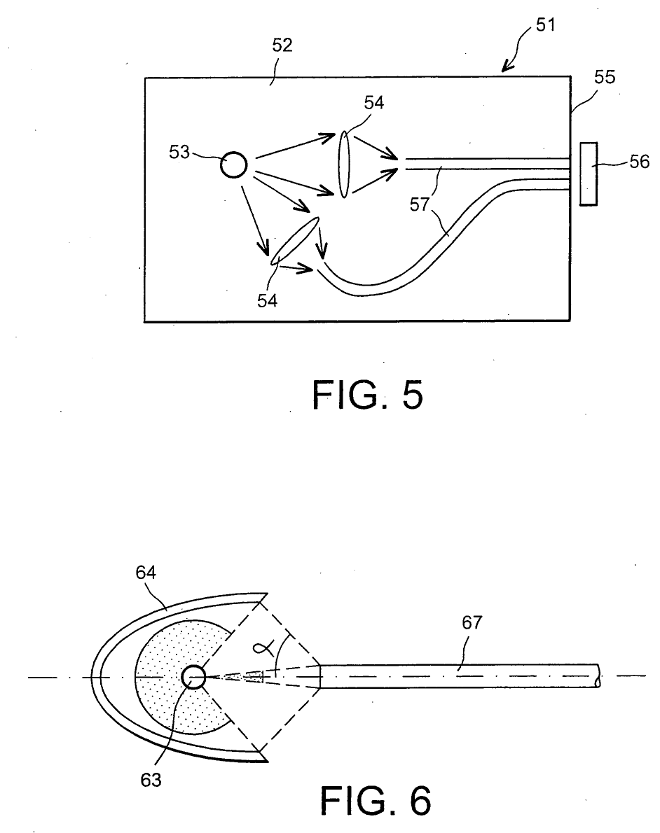

FIG. 5 is an overhead view showing a system for refocusing the fluorescent light. On the optical guiding plane 52 of a test device 51, a single test contact 53 has been represented. Two focusing lenses 54 formed on the optical guiding plane 52 make it possible to recover a part of the fluorescent light coming from the contact 53. The lenses 54 focus the recovered towards a first end of the guides 57 that convey the recovered light towards a photodetector 56 situated on the wafer 55 of the device 51.

FIG. 6 is an explanatory diagram of the operation of an elliptic mirror that may be used for the present invention. The elliptic mirror 64 surrounds a contact 63. The contact 63 is placed on the axis of the mirror 64, which merges with the axis of an optical waveguide 67 arranged on the optical guiding plane.

One designates r the radius of the emission contact 63, a the large radius of the elliptic mirror, b its small radius and f its focal point. The relation between f, a and b is given by the following formula:
f=\sqrt{a²−b²}

The image of the contact by the ellipse is therefore at a distance 2f from the contact. Let d be the diameter of the guide 67, n_{c} the index at the core of the guide and n_{g} the index of the medium surrounding the core of the guide. Under these conditions, the numerical aperture NA is given by the relation:
N.A.=\sqrt{n_{c}²−n_{g}²}

and the maximum angle of light recovery in the surrounding environment (see FIG. 6) is given by the following formula:

$$α = arcsin \{ \frac{\sqrt{{n}_{c}^{2} - {n}_{g}^{2}}}{{n}_{g}} \} .$$

In this case, the sector γ of light recovered by the elliptic mirror and transmitted in the guide is given by the formula:

$$γ = 2 [ π - arctg ( \frac{f - x}{f + x} tg α ) ] where x = \frac{{tg}^{2} α \cdot {a}^{2} f - {ab}^{2} / cos α}{{b}^{2} + {a}^{2} {tg}^{2} α} .$$

To this sector one may add the light directly transmitted from the contact 63 towards the guide and corresponding to the sector β, i.e.:

$$β = 2 arctg \frac{d}{4 f}$$

The level of recovered light is therefore:

$$η = \frac{β + γ}{2 π}$$

Taking for example a guiding layer in silicon nitride confined in the silica, a 100 μm wide guide and an elliptic mirror of 1 mm large axis and 0.5 mm small axis, one obtains the following values: f=0.86 mm and η=95%.

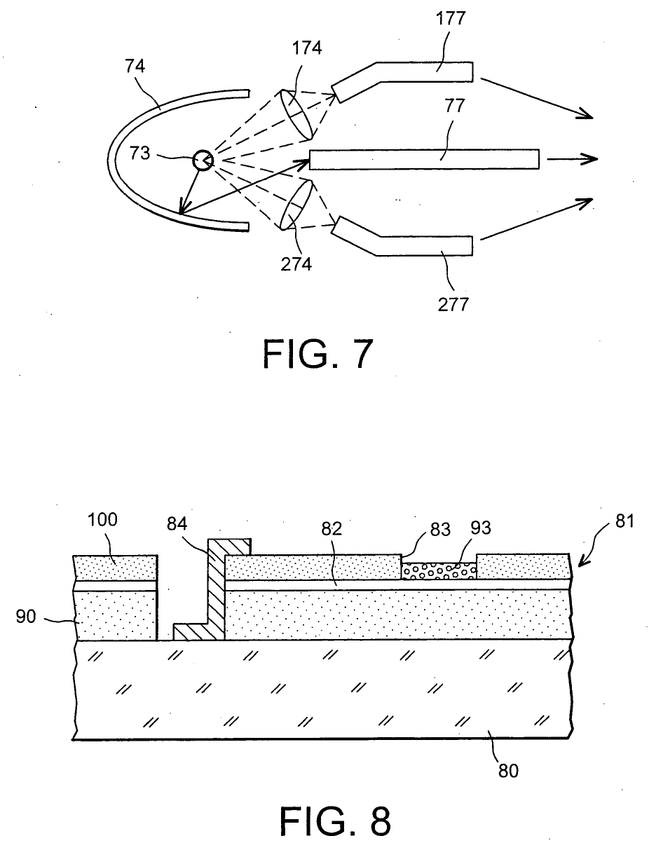

FIG. 7 shows a combination of an elliptic mirror and lenses that may be used for the present invention. The contact 73 is arranged between an elliptic mirror 74 and two focusing lenses 174 and 274. The elliptic mirror 74 sends back a part of the fluorescent light towards the guide 77 as shown in FIG. 6. The light not recovered by the elliptic mirror 74 or not directly captured by the guide 77 is practically totally recovered by the lenses 174 and 274 that focus the light received onto the ends of the guides 177 and 277 respectively. The guides 77, 177 and 277 then convey the fluorescent light emitted from the contact 73 towards a photodetector.

The light recovery structures represented in FIGS. 1 to 7 are formed in the plane of the devices, for example by photolithography and etching.

FIG. 8 is a longitudinal section view of a test device according to the present invention. The device 81 is formed from a substrate 80 that is for example in silicon for its good mechanical properties. A first layer of silica 90 is formed on the substrate 80, for example by thermal oxidation of the silicon. The layer 90 may be 1.5 μm thick, which is sufficient to optically isolate the guiding layer 82 from the substrate 80. The layer 90 therefore supports the guiding layer 82, for example in silicon nitride deposited by LPCVD. A thickness between 50 nm and 200 nm allows a monomodal guiding of the light at the classical emission wavelength of the fluorophores, from the green (0.5 μm) to the near infrared (up to 1 μm).

The guiding layer 82 supports a second layer of silica 100 deposited for example by PECVD. A thickness greater than 1 μm enables the optical waveguide of the interface layer of silica 100/air to be isolated.

Patterns are formed on the substrate coated with its different layers, for example by photolithography and reactive ion etching (RIE). Thus, the layer 100 is etched up to the guiding layer 82 in order to constitute a site 83 for receiving a sample 93 forming the fluorescent light emission contact. All of these materials are particularly interesting since grafting biological particles onto them is simple. The layers 100, 82 and 90 are etched up to the substrate 80. A mirror 84 for recovering the fluorescent light is formed there on an etching side. The mirror may consist of aluminium deposited by evaporation through a stencil type mask.

Before the deposition of the second layer of silica, the layer of silicon nitride may, if necessary, be reactive ion etched to form guides making it possible to transport the light up to the edge of the chip.

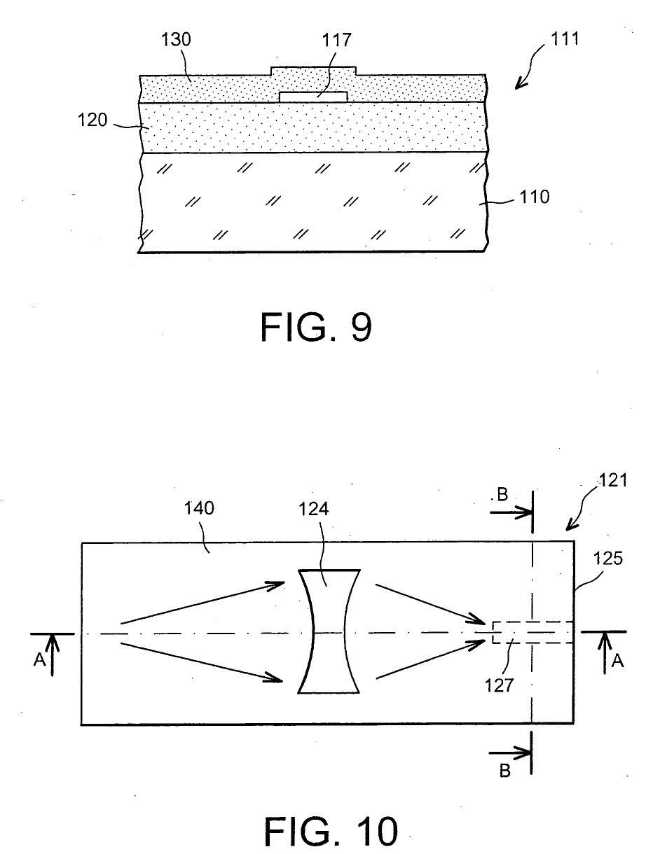

FIG. 9 is a cross-sectional view of the test device 111 having such a guide. The section shows a substrate 110 in silicon supporting a first layer of silica 120, an optical waveguide 117 in silicon nitride and a second layer of silica 130. The guide may have a width between 1 μm (limit dimension for the possibilities of contact photolithography) and several tens, or even several hundreds, of μm.

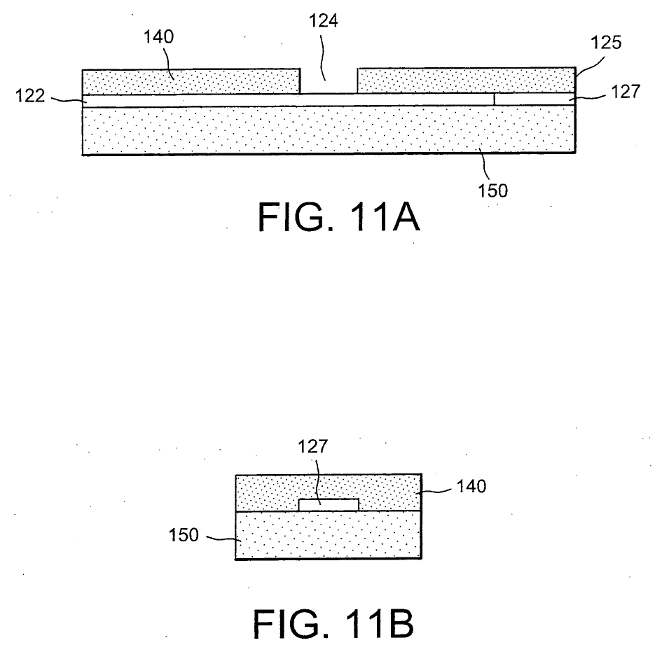

FIGS. 10, 11A and 11B relate to a part of a test device according to the invention and showing a focusing lens and an optical waveguide.

FIG. 10 is an overhead view of a part of a test device 121. It shows the upper confinement layer 140 of the guiding layer. The arrows represent the direction of propagation of a fluorescent light emitted from a contact not represented. FIG. 10 shows a focusing lens 124 and an optical waveguide 127 intended to convey the focused light up to the wafer 125 of the device 121.

The focusing lens 124 is obtained by etching of the upper confinement layer 140 until the guiding layer 122 is reached (see FIG. 11A). The lens zone having by etching a lower index than the surrounding environment, the form represented is convergent in this particular case. FIG. 11A also shows the lower confinement layer 150. The substrate has not been represented.

FIG. 11B shows the waveguide 127 intended to convey the fluorescent light, between the layers 150 and 140.

According to the invention, several optical phenomena are profitably employed by the use of integrated optic structures. The use of photonic crystals inscribed on the surface of the chip can play directly on the probability of emission of the fluorescence by “forcing” this fluorescence in a certain range of wavelength making it possible to do away with the filtering functions necessary for the detection. It is important to point out here that this does not involve a wavelength filtering that would have the effect of only keeping the part of light emitted in a certain range of wavelength but instead a mechanism “forcing” the emission at these wavelengths. All of the useful energy is therefore at the right wavelength. One thus obtains a first improvement in the quantity of light to be detected.

Then, the possibility of forming integrated structures on the chip can also make it possible to recover the light emitted in the chip more efficiently. One may form microguides transporting the light towards detectors, form mirrors enabling the emitted light to be refocused, or instead wavelength filters enabling the signal to noise ratio to be improved.

Overall, the invention enables fluorescence test systems (reader and biochip) to be obtained at very low cost. Indeed, if the lighting is not carried out by the guide but simply from above, the reading system does not require precise alignment of the chip in relation to the reader and particularly in relation to the excitation source. Furthermore, it is no longer necessary to precisely align the chip in relation to any imaging system for detecting the fluorescence contacts. Moreover, since the recovery is carried out by the wafer, one may further cut costs by choosing a strip of photodetectors rather than a matrix of photodetectors. Finally, all of the optical functions inscribed on the chip, for example the refocusing of the contact or the filtering, make it possible not to have to include these functions in the reader, which can in fact be summarised as a wide light source, a receptacle for the chip and a strip of photodetectors. Since the collection of the fluorescence is extremely efficient, such a low cost reader will moreover be a highly sensitivity reader.

1. Device for testing at least one sample by optical detection of luminescence, comprising a site for receiving the sample, said site being arranged in such a way that the sample can receive a luminescence excitation and emit a luminescence light in an optical guiding plane of the device, the device further comprising collection means optically connected to the optical guiding plane for collecting the luminescence light, wherein the device further comprises, in the optical guiding plane, means making it possible to send back towards the collection means a part of the luminescence light emitted in the optical guiding plane and not directly collected by the collection means.

2. Test device according to claim 1, wherein it further supports means of detecting the luminescence light, the detection means being arranged at the output of the collection means.

3. Test device according to claim 2, wherein the device being formed on a substrate, the optical guiding plane is a plane parallel to the substrate and the luminescence light detection means are arranged along a plane perpendicular to said plane parallel to the substrate.

4. Test device according to claim 1, wherein the means making it possible to send back a part of the luminescence light towards the collection means are chosen among: an elliptic mirror, a parabolic mirror, a photonic forbidden band structure, a resonating disc type structure and one or several focusing lenses.

5. Test device according to claim 1, wherein the collection means comprise at least one optical waveguide.

6. Test device according to claim 1, wherein the collection means are located on a wafer of the device on which said optical guiding plane ends.

7. Test device according to claim 1, wherein the excitation is a light beam and in that the collection means comprise means for filtering the excitation light beam.

8. Test device according to claim 1, wherein it comprises several sample reception sites.

9. Test device according to claim 1, wherein it is formed from a silicon substrate successively coated with a first layer of silicon oxide, a layer of silicon nitride acting as optical guiding plane and a second layer of silicon oxide in which is formed the site for receiving the sample.

10. Test device according to claim 1, wherein the sample is a biological sample chosen from among a micro-organism such as a bacteria, a fungus, a virus, a chemical compound, a healthy or tumorous cell, a molecule such as a peptide, a protein, an enzyme, a polysaccharide, a lipid, a lipoprotein, a nucleic acid, a hormone, an antigen, an antibody, a growth factor, or a hapten.

11. Test device according to claim 9, wherein the sample is a biological sample chosen from among a micro-organism such as a bacteria, a fungus, a virus, a chemical compound, a healthy or tumorous cell, a molecule such as a peptide, a protein, an enzyme, a polysaccharide, a lipid, a lipoprotein, a nucleic acid, a hormone, an antigen, an antibody, a growth factor, or a hapten.
